(19) United States
(12) Patent Application Publication
(10) Pub. No.: US 2015/0094093 A1
(43) Pub. Date: Apr. 2, 2015

(54) COMPUTING SYSTEM WITH CONFIGURATION UPDATE MECHANISM AND METHOD OF OPERATION THEREOF

(71) Applicant: Samsung Electronics Co., Ltd., Gyeonggi-Do (KR)

(72) Inventors: Jeffrey Scott Pierce, Sunnyvale, CA (US); Alan John Walendowski, San Jose, CA (US); William Aylesworth, Santa Clara, CA (US); Chunkwok Lee, Santa Clara, CA (US)

(73) Assignee: Samsung Electronics Co., Ltd., Gyeonggi-do (KR)

(21) Appl. No.: 14/039,226

(22) Filed: Sep. 27, 2013

(51) Int. Cl. H04W 4/02; H04W 64/00

(52) U.S. Cl. CPC H04W 4/021; H04W 64/00
USPC 455/456.3

(57) ABSTRACT

A computing system includes: a context module configured to determine a contextual information for representing the contextual information relative to a device; a zone module, coupled to the context module, configured to determine a proximity zone for identifying further devices within the proximity zone relative to the device; a proximate-device module, coupled to the zone module, configured to determine proximate-device identities for identifying the further devices relative to the device; and a configuration transfer module, coupled to the proximate-device module, configured to communicate a transferable configuration setting with a communication unit using the proximate-device identities for updating the device based on the transferable configuration setting and the contextual information for displaying on the device.

### TECHNICAL FIELD

An embodiment of the present invention relates generally to a computing system, and more particularly to a system for updating configurations.

### BACKGROUND

Modern consumer and industrial electronics, such as computing systems, televisions, tablets, cellular phones, portable digital assistants, projectors, and combination devices, are providing increasing levels of functionality to support modern life. In addition to the explosion of functionality and proliferation of these devices into the everyday life, there is also an explosion of data and information being created, transported, consumed, and stored.

The increasing demand for information in modern life requires users to access information at any time, while the variety of consumer devices allow for increased functionalities. However, device configurations for accommodating the information and the functionalities have often been difficult to control, such as in programming a videocassette recorder.

Thus, a need still remains for a computing system with configuration update mechanism for dynamically controlling configuration settings. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a computing system, including: a context module configured to determine a contextual information for representing the contextual information relative to a device; a zone module, coupled to the context module, configured to determine a proximity zone for identifying further devices within the proximity zone relative to the device; proximate-device module, coupled to the zone module, configured to determine proximate-device identities for identifying the further devices relative to the device; and a configuration transfer module, coupled to the proximate-device module, configured to communicate a transferable configuration setting with a communication unit using the proximate-device identities for updating the device based on the transferable configuration setting and the contextual information for displaying on the device.

An embodiment of the present invention provides a method of operation of a computing system including: determining a contextual information for representing the contextual information relative to a device; determining a proximity zone for identifying further devices within the proximity zone relative to a device; determining proximate-device identities for identifying the further devices relative to the device; and communicating a transferable configuration setting with a communication unit using the proximate-device identities for updating the device based on the transferable configuration setting for displaying on the device.

An embodiment of the present invention provides a non-transitory computer readable medium having instructions including: determining a contextual information for representing the contextual information relative to a device; determining a proximity zone for identifying further devices within the proximity zone relative to a device; determining proximate-device identities for identifying the further devices relative to the device; and communicating a transferable configuration setting with a communication unit using the proximate-device identities for updating the device based on the transferable configuration setting for displaying on the device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with configuration update mechanism in an embodiment of the present invention.

FIG. 2 is an example display of the first device.

FIG. 3 is a functional block diagram of the computing system.

FIG. 4 is a further functional block diagram of the computing system.

FIG. 5 is a control flow of the computing system.

FIG. 6 is a flow chart of a method of operation of a computing system in a further embodiment of the present invention.

### DETAILED DESCRIPTION

An embodiment of the present invention updates a downloading-device profile based on contextual information, including a future context. A transferable configuration setting is exchanged between devices based on a proximity zone, a transfer trigger, a contextual time-mark, a transfer offset, or a combination thereof associated with the contextual information. One or more devices can exchange the transferable configuration setting, update the downloading-device profile according to the transferable configuration setting, communicate a configuration notification to a user, or a combination thereof. The exchange or the update can be based on settings for the devices within the proximity zone.

An embodiment of the present invention includes the transferable configuration setting to provide contextually relevant configurations with minimal burden on the user. The transferable configuration setting and the future context further provide timely and contextually relevant features to the user.

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in the present invention in accordance with the context in which the term is used. For example, the software can be machine code, firmware, embedded code, and application software. The software can also include a function, a call to a function, a code block, or a combination thereof. Also for example, the hardware can be circuitry, processor, computer, integrated circuit, integrated circuit cores, a pressure sensor, an inertial sensor, a microelectromechanical system (MEMS), passive devices, physical non-transitory memory medium having instructions for performing the software function, or a combination thereof.

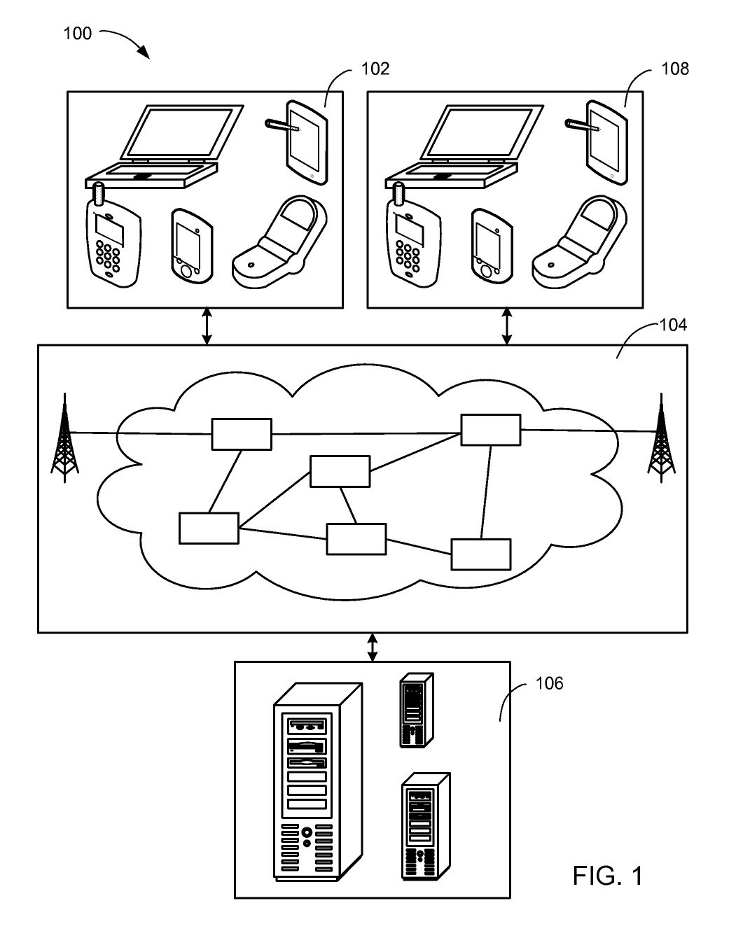

Referring now to FIG. 1, therein is shown a computing system 100 with configuration update mechanism in an embodiment of the present invention. The computing system 100 includes a first device 102, such as a client or a server, connected to a second device 106, such as a client or server, a neighboring device 108, such as a client or server, or a combination thereof. The first device 102 can communicate with the second device 106, the neighboring device 108, or a combination thereof with a communication path 104, such as a wireless or wired network.

Users of the first device 102, the second device 106, the neighboring device 108, or a combination thereof can communicate with each other or access or create information including text, images, symbols, location information, and audio, as examples. The users can be individuals or enterprise companies. The information can be created directly from a user or operations performed on these information to create more or different information.

The first device 102, the further device 108, or a combination thereof can be of any of a variety of devices, such as a smartphone, a cellular phone, personal digital assistant, a tablet computer, a notebook computer, or other multi-functional display or entertainment device. The first device 102, the neighboring device 108, or a combination thereof can couple, either directly or indirectly, to the communication path 104 for exchanging information with the second device 106 or each other, or can be a stand-alone device.

For illustrative purposes, the computing system 100 is described with the first device 102 and the neighboring device 108 as a portable multi-functional device, although it is understood that the first device 102 and the neighboring device 108 can be different types of devices. For example, the first device 102, the neighboring device 108, or a combination thereof can also be a workstation or a multi-media presentation. A multi-media presentation can be a presentation including sound, a sequence of streaming images or a video feed, text or a combination thereof.

The second device 106 can be any of a variety of centralized or decentralized computing devices, or video transmission devices. For example, the second device 106 can be a multimedia computer, a laptop computer, a desktop computer, a video game console, grid-computing resources, a virtualized computer resource, cloud computing resource, routers, switches, peer-to-peer distributed computing devices, a media playback device, a recording device, such as a camera or video camera, or a combination thereof. In another example, the second device 106 can be a server at a service provider or a computing device at a transmission facility.

The second device 106 can be centralized in a single room, distributed across different rooms, distributed across different geographical locations, embedded within a telecommunications network. The second device 106 can couple with the communication path 104 to communicate with the first device 102, the neighboring device 108, or a combination thereof.

For illustrative purposes, the computing system 100 is described with the second device 106 as a computing device, although it is understood that the second device 106 can be different types of devices. Also for illustrative purposes, the computing system 100 is shown with the second device 106, the first device 102, and the neighboring device 108 as end points of the communication path 104, although it is understood that the computing system 100 can have a different partition between the first device 102, the second device 106, and the communication path 104. For example, the first device 102, the second device 106, or a combination thereof can also function as part of the communication path 104.

For further illustrative purposes, the computing system 100 is described with the first device 102 and the neighboring device 108 as a consumer device or a portable device, and with the second device 106 as a stationary or an enterprise device. However, it is understood that the first device 102, the neighboring device 108, and the second device 106 can be any variety of devices. For example, the first device 102, the neighboring device 108, or a combination thereof can be a stationary device or an enterprise system, such as a television or a server. Also for example, the second device 106 can be a consumer device or a portable device, such as a smart phone or a wearable device.

The communication path 104 can span and represent a variety of network types and network topologies. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

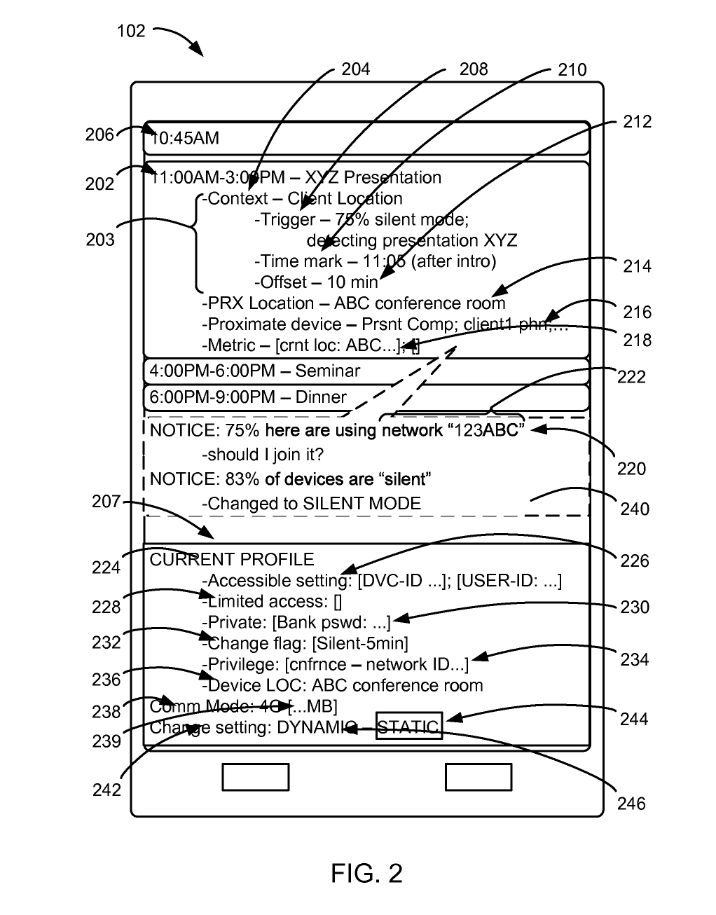

Referring now to FIG. 2, therein is shown an example display of the first device 102. The display can show an event 202. The event 202 is an occurrence or a happening. The event 202 can be the occurrence or the happening for an action, a condition, a factor, or a combination thereof. The event 202 can be based on a group of people, surrounding environment, state or output of a device, or a combination thereof. The event 202 can further include an organized occasion.

For example, the event 202 can include a device entering or leaving a specific area, a device changing state or mode, a current time being a specific predetermined time, weather, or a combination thereof. Also for example, the event 202 can include the user being around a certain person or a certain group of people or entities, the user's location entering or leaving a specific area, or a combination thereof. For further example, the event 202 can include a sporting event, a party, a professional gathering, such as attendance for a trade show or a staff meeting, a class, or a combination thereof.

The display can further show contextual information 203 regarding the event 202, including a future context 204. The contextual information 203 is situational or environmental information for the event 202. The contextual information 203 can include a purpose, a meaning, a reason, a significance or importance, or a combination thereof associated with the event 202.

The contextual information 203 can be represented by a title or a name, a categorization, a time and a location, or a combination thereof for the event 202. The contextual information 203 can be based on entities involved in the event 202, such as a common trait or a purpose for the people or organizations associated with the event 202. The future context 204 is the contextual information 203 corresponding to the event 202 occurring after a current time 206.

The computing system 100 can transfer a device configuration 207 between devices, such as the first device 102, the neighboring device 108 of FIG. 1, the second device 106 of FIG. 1, or a combination thereof. The device configuration 207 is a specified method or a setting for operating the device. The device configuration 207 can be implemented for hardware or software. The device configuration 207 can be represented by a selection of an option, identification of specific feature or function and corresponding setting information, a condition or an input value and a corresponding set of instructions or output value, or a combination thereof.

For example, the device configuration 207 can include display or arrangement of icons or a group of actions selected to be to be automatically performed based on specified conditions. Also for example, the device configuration 207 can include a physical switch setting or a corresponding software value for controlling display, sound, device function, device performance, or a combination thereof. For further example, the device configuration 207 can include instructions, access information, preferences and methods, or a combination thereof for accessing information, communicating and interacting with other devices, or a combination thereof.

The device configuration 207 can include current configuration setting, or a portion thereof, for the first device 102, the further device 108, the second device 106, or a combination thereof. The device configuration 207 can further include a setting stored in the first device 102, the further device 108, the second device 106, or a combination thereof.

The computing system 100 can transfer the device configuration 207 based on the event 202, the contextual information 203 associated therewith, or a combination thereof. The computing system 100 can transfer the device configuration 207 based on the future context 204. The computing system 100 can transfer the device configuration 207 at the current time 206 based on the future context 204.

The future context 204 can include a transfer trigger 208. The transfer trigger 208 is a condition or a factor used to initiate an exchange in the device configuration 207 between devices. The transfer trigger 208 can include the condition or the factor based on the user, the transferring device, another device, a surrounding environment, a time, or a combination thereof.

For example, the transfer trigger 208 can include an existence of a device within a specified area, a specific time, a user command, a location of the sending or the receiving device, a number of devices having a specific value or instance for the device configuration 207, or a combination thereof. As a more specific example, the transfer trigger 208 can include when majority of the devices in the same room are in “silent” mode, when the projection device or the main computer starts a “presentation mode” for a meeting, when the user makes a phone call or starts driving, fifteen minutes before a specific meeting, or a combination thereof.

The future context 204 can further include a contextual time-mark 210. The contextual time-mark 210 is a representation of a time of relevance for the event 202 corresponding to the future context 204. The contextual time-mark 210 can be after the current time 206. The contextual time-mark 210 can be a starting time, an ending time, a specific time or duration during the occurrence of the event 202, or a combination thereof.

The computing system 100 of FIG. 1 can calculate a transfer offset 212. The transfer offset 212 can be a representation of a time different and based on the contextual time-mark 210. The transfer offset 212 can be a time before or after the contextual time-mark 210. The transfer offset 212 can be a duration before or after the contextual time-mark 210. The computing system 100 can transfer the device configuration 207 between various devices based on the contextual time-mark 210 and the transfer offset 212.

The display can further show a proximity zone 214, a proximate-device identity 216, a trigger metric 218, and a transferable configuration setting 220. The proximity zone 214 is an area relative to the first device 102, the second device 106, the neighboring device 108, or a combination thereof for transferring the device configuration 207. The proximity zone 214 can be represented by a distance, a boundary, a specific area, or a combination thereof around the first device 102, the second device 106, the neighboring device 108, or a combination thereof. The proximity zone 214 can be based on the future context 204.

The proximate-device identity 216 is identification information of a device within the proximity zone 214. The proximate-device identity 216 can be a serial number, a network identification number, a communication address, a product name, an arbitrary moniker, or a combination thereof representing the first device 102, the second device 106, the neighboring device 108, or a combination thereof.

The trigger metric 218 is a value or information representing a condition or a factor associated with a device for initiating the exchange in the device configuration 207 between devices. The trigger metric 218 can be based on the transfer trigger 208. The trigger metric 218 a representation of conditions or factors associated with the first device 102, the second device 106, the neighboring device 108, or a combination thereof.

The trigger metric 218 can be the representation of conditions or factors specified by the transfer trigger 208. The transfer trigger 208 can be compared to the transfer trigger 208 for initiating the exchange between the first device 102, the second device 106, the neighboring device 108, or a combination thereof.

The transferable configuration setting 220 is the device configuration 207 that can be exchanged between devices. The transferable configuration setting 220 can include the specific method or the setting for operating the device, which can be shared with another device. The transferable configuration setting 220 can include a function, a category, an option, or a combination thereof and an associated value.

For example, the transferable configuration setting 220 can be a table or a data structure identifying one or more feature or capability for one or more device, such as a current or stored configuration of the transmitting device or surrounding devices. Also for example, the transferable configuration setting 220 can include values and information for performing various functions, such as protocol, access information, relative identification information, or a combination thereof for communication or data processing.

The display can show a device profile, such as an uploading-device profile 222, the downloading-device profile 224, or a combination thereof. The device profile is information describing a specific device. The device profile can include identification information, current setting or operational information, or a combination thereof for the device. The device profile can also include a designated setting or operational information of the device. The device profile can include the device configuration 207 of the corresponding device.

The device profile can have a setting name, a setting value, an old value, a new value, or a combination thereof. The setting name can be identification for a specific function or a category for the setting. The device profile can have multiple instances of the setting name associated with the setting value representing the current setting of the device or associated with the old and the new values.

For example, the device profile can include identification or access information based on various access privileges, device or user identification information, grouping or membership information, location-based information, usage information, or a combination thereof. As a more specific example, the device profile can include the browsing or call history, stored passwords, current location or heading of the device, schedule information, current modes, such as “silent mode” or “work mode”, or a combination thereof.

The uploading-device profile 222 is the device profile of a device providing the transferable configuration setting 220 to another device. The downloading-device profile 224 is the device profile of a different device receiving the transferable configuration setting 220 from the device providing the transferable configuration setting 220.

For example, the first device 102 having the downloading-device profile 224 can receive the transferable configuration setting 220 from the second device 106 or the neighboring device 108 having the uploading-device profile 222. Also for example, the first device 102 can have the uploading-device profile 222 and transmit the transferable configuration setting 220 to the second device 106, the neighboring device 108, or a combination thereof having a common instance or device-specific instances of the downloading-device profile 224.

The device profile can include an accessible setting 226, a limited-access setting 228, a private setting 230, a setting-change flag 232, an access privilege 234, a device location 236, or a combination thereof. The accessible setting 226 is public information associated with the device. The accessible setting 226 can include information that can be shared without specific identification or accessibility information.

For example, the accessible setting 226 can include a sound setting or volume level, a user identification information, a device identification information, a group identifier for the device, such as family or project group, a display color or brightness, or a combination thereof. Also for example, the accessible setting 226 can include information designated by the user, the computing system 100, a service provider, or a combination thereof as being openly accessible.

The limited-access setting 228 is information accessible based on privilege or specific requirement. The limited-access setting 228 can include information that can be shared based on specific device identification, common membership information, password, or a combination thereof.

For example, the accessible setting 226 can include network access information based on device and user identification, program or content access information for family members, instructors, or coworkers. Also for example, the accessible setting 226 can include other information designated by the user, the computing system 100, a service provider, or a combination thereof as being accessible based on further specified corresponding requirements.

The private setting 230 is information inaccessible for other devices without explicit action or input from the user. The private setting 230 can include browsing history, stored documents, stored passwords, call history, protected files, or a combination thereof. The private setting 230 can be based on specific identification or a categorization of the user, the computing system 100, a service provider, or a combination thereof.

The setting-change flag 232 is an indication of change in the device configuration 207 corresponding to the transferable configuration setting 220. The setting-change flag 232 can be a notification or a representation of a state in the uploading-device profile 222 or the downloading-device profile 224 for information associated with sharing the transferable configuration setting 220. For example, the setting-change flag 232 can be for indicating a change to “silent-mode” or operational status of the first device 102, the second device 106, the neighboring device 108, or a combination thereof.

The access privilege 234 is a description of relationship or familiarity for sending or receiving various information. The access privilege 234 can be represented by password, membership information, relationship information, identification information, previously shared information, prior interactions, or a combination thereof. The access privilege 234 can further be represented by category values, access or familiarity level, a degree of separation, number or frequency of interaction, types of interactions, or a combination thereof as determined by the computing system 100, the user, the service provider, or a combination thereof.

The device location 236 can be the navigation information associated with the first device 102, the second device 106, the neighboring device 108, or a combination thereof. For example, the device location 236 can be a current location, a projected future location, a prior location, or a combination thereof for a device. Also for example, the device location 236 can be an address or a set of coordinates representing the location of the user, other people, contextually relevant location, or a combination thereof.

The content or the device profile for various devices can be based on contextual information 203, ownership or control of the device, or a combination thereof. For example, the uploading-device profile 222 and the downloading-device profile 224 can be based on exchange of information or roles of devices involved in the communication. As a more specific example, the uploading-device profile 222 and the downloading-device profile 224 can be contextually relative for personal devices exchanging information or contextually fixed for a server and a client device.

Also for example, information determined as the accessible setting 226, the limited-access setting 228, the private setting 230, or a combination thereof can be based on ownership of the device, the context, or a combination thereof. As a more specific example, no information may be included in the private setting 230 for devices owned by a corporation and issued to an employee. Also as a more specific example, the limited-access setting 228 can include employee identification information of the employee using the device for other devices owned by the corporation or project specific information accessible only by devices associated with the project group.

The display can further show a communication mode 238, a configuration notification 240, a change setting 242, or a combination thereof. The communication mode 238 is a method or a way of sharing information between devices. The communication mode 238 can include the communication medium or protocol, a facilitating device or service, or a combination thereof.

For example, the communication mode 238 can include wired or wireless, direct communication between client devices, communication with or through a server, or a combination thereof. As a more specific example, the communication mode 238 can specify WiFi, cable service at home, a specific router or network at work, Bluetooth, IrDA, or a combination thereof for exchanging information between applicable devices.

The communication mode 238 can include a communication rate 239. The communication rate 239 is a representation of speed for exchanging the information using the corresponding instance of the communication mode 238. The communication rate 239 can include a measured current speed, a projected or estimated speed, a maximum speed, or a combination thereof. The communication rate 239 can further include an error rate, a repeat rate, a failure rate, a rate specific to a grouping or a type of data, or a combination thereof.

The configuration notification 240 is an indication for the user regarding the device configuration 207. The configuration notification 240 can be based on the transferable configuration setting 220. For example, the configuration notification 240 can be an interface or a prompt to the user regarding permission or selection for exchanging the transferable configuration setting 220. Also for example, the configuration notification 240 can be a message informing the user of receiving and implementing the transferable configuration setting 220.

The change setting 242 is a set of values or a process for exchanging or implementing the transferable configuration setting 220. For example, the change setting 242 can include a dynamic setting 244, a static setting 246, or a combination thereof.

The dynamic setting 244 is a set of values or a process for downloading the transferable configuration setting 220, implementing the transferable configuration setting 220, or a combination thereof based on conditions or environmental factors. The dynamic setting 244 can be for downloading or processing the transferable configuration setting 220 without specific user interaction, before the configuration notification 240, or a combination thereof.

The static setting 246 is a set of values or a process for downloading the transferable configuration setting 220, implementing the transferable configuration setting 220, or a combination thereof based on user interaction. For example, the static setting 246 can be for downloading or processing the transferable configuration setting 220 according to user command or selection, after the configuration notification 240, or a combination thereof.

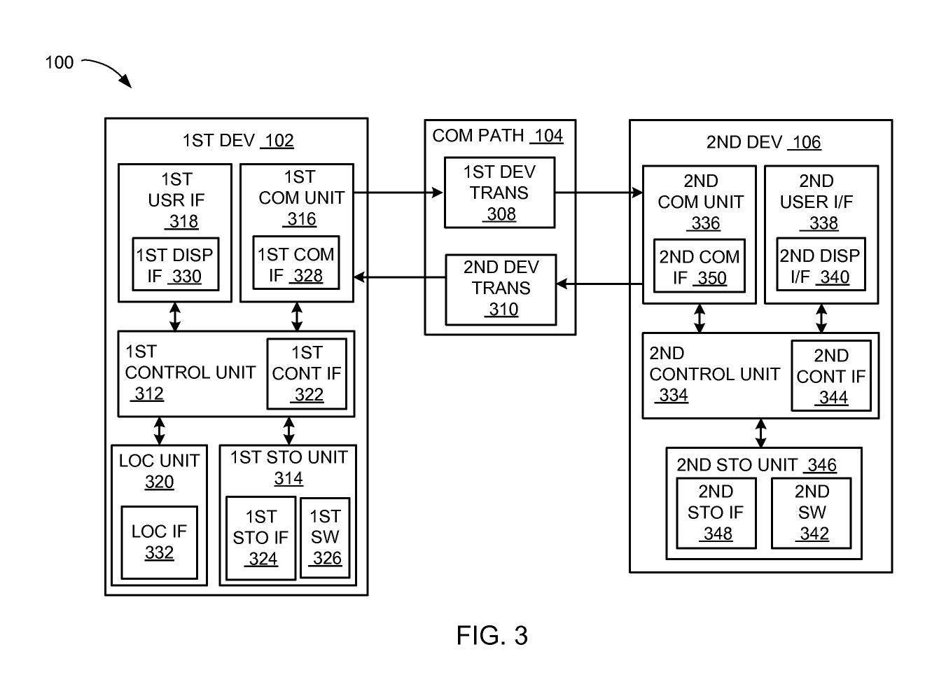

Referring now to FIG. 3, therein is shown an exemplary block diagram of the computing system 100. The computing system 100 can include the first device 102, the communication path 104, and the second device 106. The first device 102 can send information in a first device transmission 308 over the communication path 104 to the second device 106. The second device 106 can send information in a second device transmission 310 over the communication path 104 to the first device 102.

For illustrative purposes, the computing system 100 is shown with the first device 102 as a client device, although it is understood that the computing system 100 can have the first device 102 as a different type of device. For example, the first device 102 can be a server having a display interface.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 312, a first storage unit 314, a first communication unit 316, and a first user interface 318, and a location unit 320. The first control unit 312 can include a first control interface 322. The first control unit 312 can execute a first software 326 to provide the intelligence of the computing system 100.

The first control unit 312 can be implemented in a number of different manners. For example, the first control unit 312 can be a processor, an application specific integrated circuit (ASIC) an embedded processor, a microprocessor, a hardware control logic, a hardware finite state machine (FSM), a digital signal processor (DSP), or a combination thereof. The first control interface 322 can be used for communication between the first control unit 312 and other functional units in the first device 102. The first control interface 322 can also be used for communication that is external to the first device 102.

The first control interface 322 can receive information from the other functional units or from external sources, or can transmit information to the other functional units or to external destinations. The external sources and the external destinations refer to sources and destinations external to the first device 102.

The first control interface 322 can be implemented in different ways and can include different implementations depending on which functional units or external units are being interfaced with the first control interface 322. For example, the first control interface 322 can be implemented with a pressure sensor, an inertial sensor, a microelectromechanical system (MEMS), optical circuitry, waveguides, wireless circuitry, wireline circuitry, or a combination thereof.

The first storage unit 314 can store the first software 326. The first storage unit 314 can also store the relevant information, such as data representing incoming images, data representing previously presented image, sound files, or a combination thereof.

The first storage unit 314 can be a volatile memory, a nonvolatile memory, an internal memory, an external memory, or a combination thereof. For example, the first storage unit 314 can be a nonvolatile storage such as non-volatile random access memory (NVRAM), Flash memory, disk storage, or a volatile storage such as static random access memory (SRAM).

The first storage unit 314 can include a first storage interface 324. The first storage interface 324 can be used for communication between the first storage unit 314 and other functional units in the first device 102. The first storage interface 324 can also be used for communication that is external to the first device 102.

The first storage interface 324 can receive information from the other functional units or from external sources, or can transmit information to the other functional units or to external destinations. The external sources and the external destinations refer to sources and destinations external to the first device 102.

The first storage interface 324 can include different implementations depending on which functional units or external units are being interfaced with the first storage unit 314. The first storage interface 324 can be implemented with technologies and techniques similar to the implementation of the first control interface 322.

The first communication unit 316 can enable external communication to and from the first device 102. For example, the first communication unit 316 can permit the first device 102 to communicate with the second device 106 of FIG. 1, an attachment, such as a peripheral device or a desktop computer, and the communication path 104.

The first communication unit 316 can also function as a communication hub allowing the first device 102 to function as part of the communication path 104 and not limited to be an end point or terminal unit to the communication path 104. The first communication unit 316 can include active and passive components, such as microelectronics or an antenna, for interaction with the communication path 104.

The first communication unit 316 can include a first communication interface 328. The first communication interface 328 can be used for communication between the first communication unit 316 and other functional units in the first device 102. The first communication interface 328 can receive information from the other functional units or can transmit information to the other functional units.

The first communication interface 328 can include different implementations depending on which functional units are being interfaced with the first communication unit 316. The first communication interface 328 can be implemented with technologies and techniques similar to the implementation of the first control interface 322.

The first user interface 318 allows a user (not shown) to interface and interact with the first device 102. The first user interface 318 can include an input device and an output device. Examples of the input device of the first user interface 318 can include a keypad, a touchpad, soft-keys, a keyboard, a microphone, an infrared sensor for receiving remote signals, or any combination thereof to provide data and communication inputs.

The first user interface 318 can include a first display interface 330. The first display interface 330 can include an output device, such as the display interface 202 of FIG. 2. The first display interface 330 can include a display, a projector, a video screen, a speaker, or any combination thereof.

The first control unit 312 can operate the first user interface 318 to display information generated by the computing system 100. The first control unit 312 can also execute the first software 326 for the other functions of the computing system 100, including receiving location information from the location unit 320. The first control unit 312 can further execute the first software 326 for interaction with the communication path 104 via the first communication unit 316.

The location unit 320 can generate location information, current heading, current acceleration, and current speed of the first device 102, as examples. The location unit 320 can be implemented in many ways. For example, the location unit 320 can function as at least a part of the global positioning system, an inertial computing system, a cellular-tower location system, a pressure location system, or any combination thereof. Also, for example, the location unit 620 can utilize components such as an accelerometer or GPS receiver.

The location unit 320 can include a location interface 332. The location interface 332 can be used for communication between the location unit 320 and other functional units in the first device 102. The location interface 632 can also be used for communication external to the first device 102.

The location interface 332 can receive information from the other functional units or from external sources, or can transmit information to the other functional units or to external destinations. The external sources and the external destinations refer to sources and destinations external to the first device 102.

The location interface 332 can include different implementations depending on which functional units or external units are being interfaced with the location unit 320. The location interface 332 can be implemented with technologies and techniques similar to the implementation of the first control unit 312.

The second device 106 can be optimized for implementing an embodiment of the present invention in a multiple device embodiment with the first device 102. The second device 106 can provide the additional or higher performance processing power compared to the first device 102. The second device 106 can include a second control unit 334, a second communication unit 336, a second user interface 338, and a second storage unit 346.

The second user interface 338 allows a user (not shown) to interface and interact with the second device 106. The second user interface 338 can include an input device and an output device. Examples of the input device of the second user interface 338 can include a keypad, a touchpad, soft-keys, a keyboard, a microphone, or any combination thereof to provide data and communication inputs. Examples of the output device of the second user interface 338 can include a second display interface 340. The second display interface 340 can include a display, a projector, a video screen, a speaker, or any combination thereof.

The second control unit 334 can execute a second software 342 to provide the intelligence of the second device 106 of the computing system 100. The second software 342 can operate in conjunction with the first software 326. The second control unit 334 can provide additional performance compared to the first control unit 312.

The second control unit 334 can operate the second user interface 338 to display information. The second control unit 334 can also execute the second software 342 for the other functions of the computing system 100, including operating the second communication unit 336 to communicate with the first device 102 over the communication path 104.

The second control unit 334 can be implemented in a number of different manners. For example, the second control unit 334 can be a processor, an embedded processor, a microprocessor, hardware control logic, a hardware finite state machine (FSM), a digital signal processor (DSP), or a combination thereof.

The second control unit 334 can include a second control interface 344. The second control interface 344 can be used for communication between the second control unit 334 and other functional units in the second device 106. The second control interface 344 can also be used for communication that is external to the second device 106.

The second control interface 344 can receive information from the other functional units or from external sources, or can transmit information to the other functional units or to external destinations. The external sources and the external destinations refer to sources and destinations external to the second device 106.

The second control interface 344 can be implemented in different ways and can include different implementations depending on which functional units or external units are being interfaced with the second control interface 344. For example, the second control interface 344 can be implemented with a pressure sensor, an inertial sensor, a microelectromechanical system (MEMS), optical circuitry, waveguides, wireless circuitry, wireline circuitry, or a combination thereof.

A second storage unit 346 can store the second software 342. The second storage unit 346 can also store the information such as data representing incoming images, data representing previously presented image, sound files, or a combination thereof. The second storage unit 346 can be sized to provide the additional storage capacity to supplement the first storage unit 314.

For illustrative purposes, the second storage unit 346 is shown as a single element, although it is understood that the second storage unit 346 can be a distribution of storage elements. Also for illustrative purposes, the computing system 100 is shown with the second storage unit 346 as a single hierarchy storage system, although it is understood that the computing system 100 can have the second storage unit 346 in a different configuration. For example, the second storage unit 346 can be formed with different storage technologies forming a memory hierarchal system including different levels of caching, main memory, rotating media, or off-line storage.

The second storage unit 346 can be a volatile memory, a nonvolatile memory, an internal memory, an external memory, or a combination thereof. For example, the second storage unit 346 can be a nonvolatile storage such as non-volatile random access memory (NVRAM), Flash memory, disk storage, or a volatile storage such as static random access memory (SRAM).

The second storage unit 346 can include a second storage interface 348. The second storage interface 348 can be used for communication between the second storage unit 346 and other functional units in the second device 106. The second storage interface 348 can also be used for communication that is external to the second device 106.

The second storage interface 348 can receive information from the other functional units or from external sources, or can transmit information to the other functional units or to external destinations. The external sources and the external destinations refer to sources and destinations external to the second device 106.

The second storage interface 348 can include different implementations depending on which functional units or external units are being interfaced with the second storage unit 346. The second storage interface 348 can be implemented with technologies and techniques similar to the implementation of the second control interface 344.

The second communication unit 336 can enable external communication to and from the second device 106. For example, the second communication unit 336 can permit the second device 106 to communicate with the first device 102 over the communication path 104.

The second communication unit 336 can also function as a communication hub allowing the second device 106 to function as part of the communication path 104 and not limited to be an end point or terminal unit to the communication path 104. The second communication unit 336 can include active and passive components, such as microelectronics or an antenna, for interaction with the communication path 104.

The second communication unit 336 can include a second communication interface 350. The second communication interface 350 can be used for communication between the second communication unit 336 and other functional units in the second device 106. The second communication interface 350 can receive information from the other functional units or can transmit information to the other functional units.

The second communication interface 350 can include different implementations depending on which functional units are being interfaced with the second communication unit 336. The second communication interface 350 can be implemented with technologies and techniques similar to the implementation of the second control interface 344.

The first communication unit 316 can couple with the communication path 104 to send information to the second device 106 in the first device transmission 308. The second device 106 can receive information in the second communication unit 336 from the first device transmission 308 of the communication path 104.

The second communication unit 336 can couple with the communication path 104 to send information to the first device 102 in the second device transmission 310. The first device 102 can receive information in the first communication unit 316 from the second device transmission 310 of the communication path 104. The computing system 100 can be executed by the first control unit 312, the second control unit 334, or a combination thereof. For illustrative purposes, the second device 106 is shown with the partition having the second user interface 338, the second storage unit 346, the second control unit 334, and the second communication unit 336, although it is understood that the second device 106 can have a different partition. For example, the second software 342 can be partitioned differently such that some or all of its function can be in the second control unit 334 and the second communication unit 336. Also, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the computing system 100 is described by operation of the first device 102 and the second device 106. It is understood that the first device 102 and the second device 106 can operate any of the modules and functions of the computing system 100.

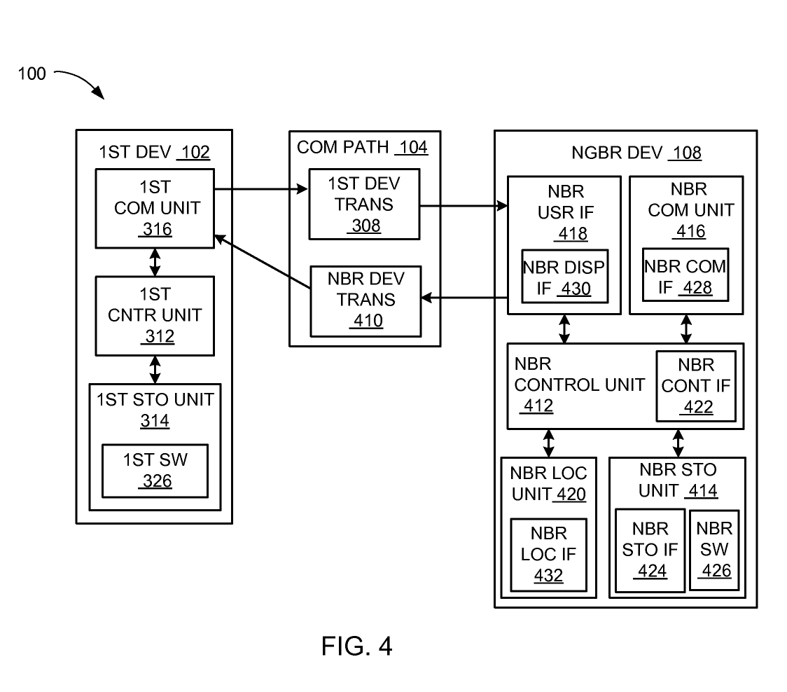

Referring now to FIG. 4, therein is shown a further exemplary block diagram of the computing system 100. Along with the first device 102 and the second device 106 of FIG. 3, the computing system 100 can include the neighboring device 108. The first device 102 can send information in the first device transmission over the communication path 104 to the neighboring device 108. The neighboring device 108 can send information in a neighboring-device transmission 410 over the communication path 104 to the first device 102.

For illustrative purposes, the computing system 100 is shown with the neighboring device 108 as a portable consumer device, although it is understood that the computing system 100 can have the neighboring device 108 as a different type of device. For example, the neighboring device 108 can be a server device.

Also for illustrative purposes, the computing system 100 is shown with the first device 102 communicating with the neighboring device 108. However, it is understood that the second device 106 can also communicate with the neighboring device 108 in a similar manner as the communication between the first device 102 and the neighboring device 108, between the first device 102 and the second device 106, or a combination thereof.

For brevity of description in this embodiment of the present invention, the neighboring device 108 will be described as a client device. The embodiment of the present invention is not limited to this selection for the type of devices. The selection is an example of an embodiment of the present invention.

The neighboring device 108 can include a neighboring control unit 412, a neighboring storage unit 414, a neighboring communication unit 416, and a neighboring user interface 418, and a neighboring location unit 420. The neighboring control unit 412 can include a neighboring control interface 422. The neighboring control unit 412 can execute a neighboring software 426 to provide the intelligence of the computing system 100.

The neighboring control unit 412 can be implemented in a number of different manners. For example, the neighboring control unit 412 can be a processor, an application specific integrated circuit (ASIC) an embedded processor, a microprocessor, a hardware control logic, a hardware finite state machine (FSM), a digital signal processor (DSP), or a combination thereof. The neighboring control interface 422 can be used for communication between the neighboring control unit 412 and other functional units in the neighboring device 108. The neighboring control interface 422 can also be used for communication that is external to the neighboring device 108.

The neighboring control interface 422 can receive information from the other functional units or from external sources, or can transmit information to the other functional units or to external destinations. The external sources and the external destinations refer to sources and destinations external to the neighboring device 108.

The neighboring control interface 422 can be implemented in different ways and can include different implementations depending on which functional units or external units are being interfaced with the neighboring control interface 422. For example, the neighboring control interface 422 can be implemented with a pressure sensor, an inertial sensor, a microelectromechanical system (MEMS), optical circuitry, waveguides, wireless circuitry, wireline circuitry, or a combination thereof.

The neighboring storage unit 414 can store the neighboring software 426. The neighboring storage unit 414 can also store the relevant information, such as data representing incoming images, data representing previously presented image, sound files, or a combination thereof.

The neighboring storage unit 414 can be a volatile memory, a nonvolatile memory, an internal memory, an external memory, or a combination thereof. For example, the neighboring storage unit 414 can be a nonvolatile storage such as non-volatile random access memory (NVRAM), Flash memory, disk storage, or a volatile storage such as static random access memory (SRAM).

The neighboring storage unit 414 can include a neighboring storage interface 424. The neighboring storage interface 424 can be used for communication between the neighboring storage unit 414 and other functional units in the neighboring device 108. The neighboring storage interface 424 can also be used for communication that is external to the neighboring device 108.

The neighboring storage interface 424 can receive information from the other functional units or from external sources, or can transmit information to the other functional units or to external destinations. The external sources and the external destinations refer to sources and destinations external to the neighboring device 108.

The neighboring storage interface 424 can include different implementations depending on which functional units or external units are being interfaced with the neighboring storage unit 414. The neighboring storage interface 424 can be implemented with technologies and techniques similar to the implementation of the neighboring control interface 422.

The neighboring communication unit 416 can enable external communication to and from the neighboring device 108. For example, the neighboring communication unit 416 can permit the neighboring device 108 to communicate with the second device 106 of FIG. 1, the first device 102, or a combination thereof, an attachment, such as a peripheral device or a desktop computer, and the communication path 104.

The neighboring communication unit 416 can also function as a communication hub allowing the neighboring device 108 to function as part of the communication path 104 and not limited to be an end point or terminal unit to the communication path 104. The neighboring communication unit 416 can include active and passive components, such as microelectronics or an antenna, for interaction with the communication path 104.

The neighboring communication unit 416 can include a neighboring communication interface 428. The neighboring communication interface 428 can be used for communication between the neighboring communication unit 416 and other functional units in the neighboring device 108. The neighboring communication interface 428 can receive information from the other functional units or can transmit information to the other functional units.

The neighboring communication interface 428 can include different implementations depending on which functional units are being interfaced with the neighboring communication unit 416. The neighboring communication interface 428 can be implemented with technologies and techniques similar to the implementation of the neighboring control interface 422.

The neighboring user interface 418 allows a user (not shown) to interface and interact with the neighboring device 108. The neighboring user interface 418 can include an input device and an output device. Examples of the input device of the neighboring user interface 418 can include a keypad, a touchpad, soft-keys, a keyboard, a microphone, an infrared sensor for receiving remote signals, or any combination thereof to provide data and communication inputs.

The neighboring user interface 418 can include a neighboring display interface 430. The neighboring display interface 430 can include an output device, such as the display interface 202 of FIG. 2. The neighboring display interface 430 can include a display, a projector, a video screen, a speaker, or any combination thereof.

The neighboring control unit 412 can operate the neighboring user interface 418 to display information generated by the computing system 100. The neighboring control unit 412 can also execute the neighboring software 426 for the other functions of the computing system 100, including receiving location information from the neighboring location unit 420. The neighboring control unit 412 can further execute the neighboring software 426 for interaction with the communication path 104 via the neighboring communication unit 416.

The neighboring location unit 420 can generate location information, current heading, current acceleration, and current speed of the neighboring device 108, as examples. The neighboring location unit 420 can be implemented in many ways. For example, the neighboring location unit 420 can function as at least a part of the global positioning system, an inertial computing system, a cellular-tower location system, a pressure location system, or any combination thereof. Also, for example, the location unit 620 can utilize components such as an accelerometer or GPS receiver.

The neighboring location unit 420 can include a neighboring location interface 432. The neighboring location interface 432 can be used for communication between the neighboring location unit 420 and other functional units in the neighboring device 108. The location interface 632 can also be used for communication external to the neighboring device 108.

The neighboring location interface 432 can receive information from the other functional units or from external sources, or can transmit information to the other functional units or to external destinations. The external sources and the external destinations refer to sources and destinations external to the neighboring device 108.

The neighboring location interface 432 can include different implementations depending on which functional units or external units are being interfaced with the neighboring location unit 420. The neighboring location interface 432 can be implemented with technologies and techniques similar to the implementation of the neighboring control unit 412.

The first communication unit 316 can couple with the communication path 104 to send information to the neighboring device 108 in the first device transmission 308. The neighboring device 108 can receive information in the neighboring communication unit 436 from the first device transmission 308 of the communication path 104.

The neighboring communication unit 436 can couple with the communication path 104 to send information to the first device 102 in the neighboring-device transmission 410. The first device 102 can receive information in the first communication unit 316 from the neighboring-device transmission 410 of the communication path 104. The computing system 100 can be executed by the first control unit 312, the neighboring control unit 434, or a combination thereof. The second device 106 can similarly communicate and interact with the neighboring device 108 using the corresponding units and functions therein.

For illustrative purposes, the neighboring device 108 is shown with the partition having the neighboring user interface 438, the neighboring storage unit 446, the neighboring control unit 434, and the neighboring communication unit 436, although it is understood that the neighboring device 108 can have a different partition. For example, the neighboring software 442 can be partitioned differently such that some or all of its function can be in the neighboring control unit 434 and the neighboring communication unit 436. Also, the neighboring device 108 can include other functional units not shown in FIG. 4 for clarity.

The functional units in the neighboring device 108 can work individually and independently of the other functional units. The neighboring device 108 can work individually and independently from the first device 102, the second device 106, and the communication path 104.

For illustrative purposes, the computing system 100 is described by operation of the first device 102 and the neighboring device 108. It is understood that the first device 102, the second device 106, and the neighboring device 108 can operate any of the modules and functions of the computing system 100.

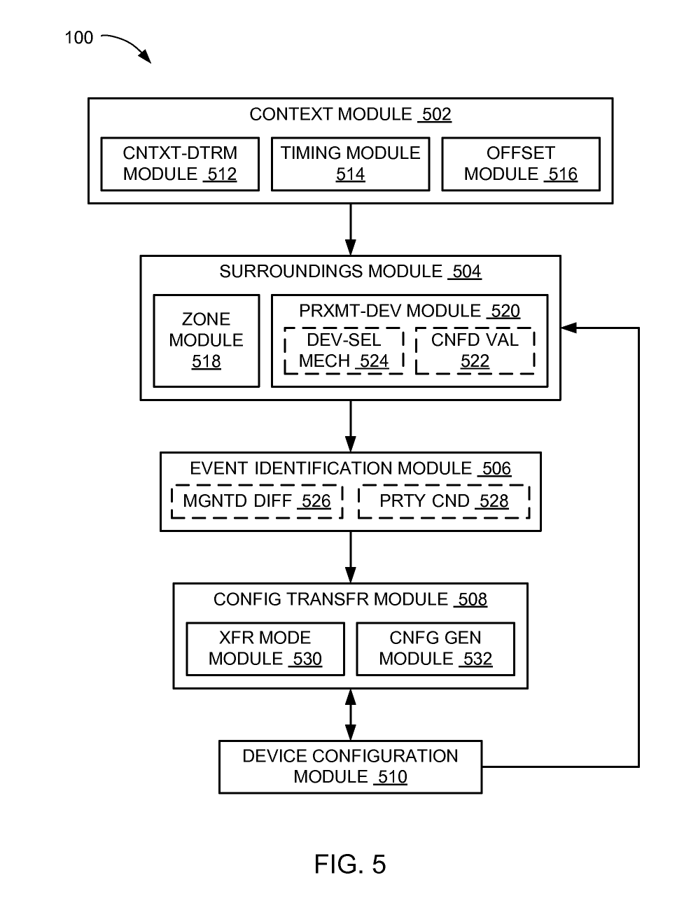

Referring now to FIG. 5, therein is shown a control flow of the computing system 100. The computing system 100 can include a context module 502, a surroundings module 504, an event identification module 506, a configuration transfer module 508, and a device configuration module 510.

The context module 502 can be coupled to the surroundings module 504 using wired or wireless connections, by having an output of one module as an input of the other module, by having operations of one module influence operation of the other module, or a combination thereof. Similarly, the surroundings module 504 can be coupled to the event identification module 506. Moreover, the configuration transfer module 508 can be similarly coupled to the device configuration module 510.

The context module 502 is configured to determine the contextual information 203 for transferring the device configuration 207 between various devices. The context module 502 can include a context-determination module 512, a timing module 514, an offset module 516, or a combination thereof. The context-determination module 512 is configured to determine the contextual information 203, including the future context 204 of FIG. 2 for transferring the device configuration 207.

The context-determination module 512 can determine the contextual information 203 including the future context 204 for describing the event 202 of FIG. 2 associated with the first device 102 of FIG. 1, the neighboring device 108 of FIG. 1, the second device 106 of FIG. 1, or a combination thereof. The context-determination module 512 can determine the contextual information 203, the future context 204, or a combination thereof to describe the event 202 based on a function or a mode appropriate or necessary for the first device 102, the neighboring device 108, the second device 106, or a combination thereof for the event 202. The context-determination module 512 can further determine the contextual information 203, the future context 204, or a combination thereof to describe the event 202 in relation to the user or a different user, or a combination thereof associated with the event 202 and having the first device 102, the neighboring device 108, the second device 106, or a combination thereof.

The context-determination module 512 can determine the contextual information 203, the future context 204, or a combination thereof by using available or associated information for the event 202 scheduled to occur or likely to occur during or after the current time 206 of FIG. 2. The context-determination module 512 can use information available on the internet, a user's calendar, a user's input, information internal to the first device 102, the second device 106, the neighboring device 108, or a combination thereof.

For example, the context-determination module 512 can determine the contextual information 203, the future context 204, or a combination thereof using the first communication unit 316 of FIG. 3, the second communication unit 336 of FIG. 3, the neighboring communication unit 416 of FIG. 4, or a combination thereof. The context-determination module 512 can determine the contextual information 203, the future context 204, or a combination thereof using a machine-learning mechanism, a pattern analysis mechanism, or a combination thereof.

Also for example, the context-determination module 512 can use the first user interface 318 of FIG. 3, the second user interface 338 of FIG. 3, the neighboring user interface 418 of FIG. 4, or a combination thereof to generate a selection set and communicate the selection set to the user. The context-determination module 512 can likewise receive a user-selection for determining the contextual information 203, including the future context 204.

The context-determination module 512 can determine the contextual information 203, the future context 204, or a combination thereof based on various types of information, including information internal to, external to, or a combination thereof with respect to the first device 102, the second device 106, the neighboring device 108, or a combination thereof. For example, the context-determination module 512 can determine the contextual information 203, the future context 204, or a combination thereof based on the user's schedule calendar, correspondences, documents, or a combination thereof for the event 202.

As a more specific example, the context-determination module 512 can determine the contextual information 203, the future context 204, or a combination thereof by determining a cluster, a model, or a combination thereof for the event 202 specified on the user's schedule calendar using various information. The context-determination module 512 can determine the cluster, the model, or a combination thereof using a title or a purpose of the event 202 in the calendar, keywords or images in a document or a correspondence, such as an email or a spread sheet, or a combination thereof stored in the first device 102, the second device 106, the neighboring device 108, a device external to the computing system 100, or a combination thereof.

Also for example, the context-determination module 512 can determine the contextual information 203, the future context 204, or a combination thereof based on a route traveled by the user, a commonality or a relationship between the user and other people within a specified area, such as within a distance from the user or in the same room with the user, historical information, or a combination thereof. As a more specific example, the context-determination module 512 perform the pattern analysis to determine a professional context, such as commuting to work or meeting a client, or a social context, such as going home or visiting a social contact, or a combination thereof, based on the route used or traveled by the user, the current time 206, historical information, or a combination thereof.

The context-determination module 512 can generate the transfer trigger 208 of FIG. 2 associated with the contextual information 203, the future context 204, or a combination thereof. The context-determination module 512 can generate the transfer trigger 208 based on the event 202, the future context 204, the contextual information 203 for the current time 206, a time, a user input, a historical data, a nearby user, or a combination thereof.

For example, the context-determination module 512 can generate the transfer trigger 208 based on a specific time associated with the event 202 having the future context 204 associated therewith based the future context 204. As a more specific example, the context-determination module 512 can generate the transfer trigger 208 based on a start or end time for professional or official instances of the event 202.

Also for example, the context-determination module 512 can generate the transfer trigger 208 based on user's familiarity with the current instance of the contextual information 203. As a more specific example, the context-determination module 512 can generate the transfer trigger 208 for user's first arrival at the current location or the event 202, first usage of a service or a device associated with the event 202, or a combination thereof as indicated by the contextual information 203.

Also for example, the context-determination module 512 can generate the transfer trigger 208 based on a user input or a user selection for changing a configuration value for the setting. As a more specific example, the context-determination module 512 can generate the transfer trigger 208 based on selections or configuration changes from the user or other participant, such as through crowd-sourcing, occurring before, during, or after events similar to the event 202 having the future context 204.

Also as a more specific example, the context-determination module 512 can generate the transfer trigger 208 based on similar selections or configuration changes, such as switching to “silent” mode or establishing the communication mode 238, for a specific amount of participants, such as a number or a percentage of event participants or people present within a set distance or the same room. The context-determination module 512 can have a predetermined method, value, table, or a combination thereof for generating the transfer trigger 208 such as setting the specific amount, identifying the set distance or the room, types of situations, types of selection or configuration changes, or a combination thereof.

It has been discovered that the transfer trigger 208 can provide contextually relevant and situation-appropriate adaptations and features for the computing system 100. The transfer trigger 208 can provide measureable and machine-relevant factors for representing the contextual information 203, including the future context 204, and the event 202 associated with the user. The computing system 100 can use the transfer trigger 208 to provide specific changes in the device configuration 207 appropriate for the context surrounding the future event.

The timing module 514 is configured to determine a time associated with the future context 204. The timing module 514 can determine the time by determining the contextual time-mark 210 of FIG. 2 for temporally representing the future context 204.

The timing module 514 can determine the contextual time-mark 210 in a variety of ways. For example, the timing module 514 can determine the contextual time-mark 210 based on a start time, a duration, an end time, or a combination thereof associated with the event 202 in the calendar. Also for example, the timing module 514 can determine the contextual time-mark 210 based on an estimated time of arrival.

For further example, the timing module 514 can determine the contextual time-mark 210 based on a participant for the event 202, identification information of a different user within an area relative to the user, historical or usage-based information thereof, calendar-based information thereof, a pattern or a combination thereof. The timing module 514 can use the first control interface 322 of FIG. 3, the second control interface 344 of FIG. 3, the neighboring control interface 422 of FIG. 4, or a combination thereof to access the information necessary to determine the contextual time-mark 210.

The offset module 516 is configured to determine an initiation time for updating the device configuration 207 in association with the future context 204. The offset module 516 can calculate the transfer offset 212 of FIG. 2 relative to the contextual time-mark 210. The offset module 516 can calculate the transfer offset 212 based on the future context 204.

For example, the offset module 516 can set the transfer offset 212 as ‘0’ to set the first device 102 to a silent device at the start of the meeting or to connect to a hotel wireless network contemporaneously with checking in to the hotel. Also for example, the offset module 516 can set the transfer offset 212 as a number of days before the event 202 for downloading configuration settings for in anticipation of and rehearsing for a major presentation, or as a time after the event 202 for processing the information obtained during the event 202.

The offset module 516 can calculate the transfer offset 212 using the first control unit 312, the second control unit 334, the neighboring control unit 412, or a combination thereof. The offset module 516 can use the first storage interface 324 of FIG. 3, the second storage interface 348 of FIG. 3, the neighboring storage interface 424 of FIG. 4, or a combination thereof to access the information necessary to calculate the transfer offset 212, such as the contextual time-mark 210 or the future context 204.

It has also been discovered that the transfer trigger 208 including the transfer offset 212 from the contextual time-mark 210 provide timely adaptations and features for the computing system 100. The transfer trigger 208 can be used to provide measureable and machine-relevant factors and the transfer offset 212 from the contextual time-mark 210 can describe an appropriate time for initiating changes in anticipation of the context surrounding the future event.

After determining the future context 204, the transfer trigger 208 associated therewith, or a combination thereof, the control flow can pass from context module 502 to the surroundings module 504. The control flow can pass by having the future context 204, the transfer trigger 208, or a combination thereof as an output from the context module 502 to an input of the surroundings module 504, storing the future context 204, the transfer trigger 208, or a combination thereof at a location known and accessible to the surroundings module 504, by notifying the surroundings module 504, such as by using a flag, an interrupt, a status signal, or a combination thereof, or a combination of processes thereof.

The surroundings module 504 is configured to process information regarding surroundings of the first device 102, the second device 106, the neighboring device 108, or a combination thereof. The surroundings module 504 can include a zone module 518, a proximate-device module 520, or a combination thereof for processing the information regarding the surroundings.

The zone module 518 is configured to determine the proximity zone 214 of FIG. 2. The zone module 518 can determine the proximity zone 214 based on the future context 204, the contextual time-mark 210, the transfer offset 212, an estimate of the communication mode 238 of FIG. 2 or the change setting 242 of FIG. 2, or a combination thereof. For example, the zone module 518 can determine the proximity zone 214 based on a boundary or a perimeter for an area associated with the corresponding instance of the event 202, the future context 204, the contextual time-mark 210, the transfer offset 212, or a combination thereof.

Also for example, the zone module 518 can determine the proximity zone 214 based on a set distance predetermined by the computing system 100. As a more specific example, the zone module 518 can adjust a distance for establishing the proximity zone 214 based on current or projected use of protocols, such as peer-to-peer communication or fourth generation cellular protocol, strength of communication signals, number of participants or devices associated with the future context 204, the communication rate 239 of FIG. 2 or a combination thereof for communication.

The zone module 518 can include a mechanism, a method, a set of correlated values representing different scenarios, such as a predetermined threshold or a preset value, or a combination thereof predetermined by the computing system 100 for determining the proximity zone 214. The zone module 518 can use the first storage interface 324 of FIG. 3, the second storage interface 348 of FIG. 3, the neighboring storage interface 424 of FIG. 4, or a combination thereof to access the mechanism, the method, the set of correlated information, or a combination thereof for determining the proximity zone 214.

The zone module 518 can determine the proximity zone 214 for identifying the first device 102, the second device 106, the neighboring device 108, or a combination thereof within the proximity zone 214. The zone module 518 can determine the proximity zone 214 relative to the first device 102, the second device 106, the neighboring device 108, or a combination thereof for identifying a further device.

For example, the zone module 518 can determine the proximity zone 214 relative to the first device 102, such as a physical boundary surrounding the first device 102 or an area defined by a radius around the first device 102. The zone module 518 can identify the neighboring device 108 within the proximity zone 214 as the further device in the same room or building as the first device 102, within a specified distance from the first device 102, or a combination thereof.

The zone module 518 can further determine the proximity zone 214 to include multiple areas. For example, the zone module 518 can determine the proximity zone 214 to have multiple values for the radius used to determine the proximity zone 214. Also for example, the zone module 518 can determine the proximity zone 214 to change between the room and the building having the first device 102 therein. The zone module 518 can select between the multiple values based on the future context 204, the communication mode 238 or the communication rate 239, or a combination thereof.

The proximate-device module 520 is configured to determine the proximate-device identity 216. The proximate-device module 520 can determine the proximate-device identity 216 for identifying the first device 102, the neighboring device 108, the second device 106, or a combination thereof. The proximate-device module 520 can determine the proximate-device identity 216 relative to another device, for transferring the device configuration 207 between the devices.

For example, the proximate-device module 520 can determine the proximate-device identity 216 relative to the first device 102, with the proximate-device identity 216 corresponding to the neighboring device 108. The computing system 100 can transfer the device configuration 207 between the first device 102 and the neighboring device 108.

For illustrative purposes, the computing system 100 has been described as transferring the device configuration 207 between the first device 102 and the neighboring device 108. However, it is understood that the computing system 100 can transfer the device configuration 207 between the first device 102 and the second device 106, the second device and the neighboring device 108, or a combination thereof. The computing system 100 can further transfer the device configuration 207 through another device, such as by communicating the device configuration 207 from the neighboring device 108 to the second device 106, and then from the second device 106 to the first device 102.

The proximate-device module 520 can determine the proximate-device identity 216 using short-range broadcast. The proximate-device module 520 can use encryption for the short-range broadcast. The proximate-device module 520 can further use multiple or sequential broadcasts, such as having both unencrypted broadcast and encrypted broadcast or broadcasting in either encrypted or unencrypted format based on information received during an initial exchange.

The proximate-device module 520 can use the first communication unit 316, the second communication unit 336, the neighboring communication unit 416, or a combination thereof to initiate communication, exchange preliminary information from the device profile, such as the accessible setting 226 of FIG. 2 or the device identification, update changes in the status or mode, such as by transmitting the setting-change flag 232 of FIG. 2, or a combination thereof. The proximate-device module 520 can determine the proximate-device identity 216 by identifying one or more devices that respond to or initiate the short-range broadcast.

The proximate-device module 520 can further determine the proximate-device identity 216 by identifying one or more device within the proximity zone 214, and by selecting a device from the identified device. The proximate-device module 520 can identify the one or more devices within the proximity zone 214 by comparing the device location 236 in the device profile of a device responding to a communication including the short-range communication.

For example, the first device 102 can use the first device transmission 308 of FIG. 3 to broadcast a query or ping any nearby device. One or more devices can respond to the query or the ping and provide identification information, the device location 236, the device profile, or a combination thereof corresponding to the responding device. The proximate-device module 520 can compare the proximity zone 214 to the device location 236 to identify the one or more device within the proximity zone 214.

The proximate-device module 520 can further select from the identified devices to determine the proximate-device identity 216. The proximate-device module 520 can select based on determining the device profile, such as the uploading-device profile 222 of FIG. 2, the downloading-device profile 224 of FIG. 2, or a combination thereof.

The proximate-device module 520 can determine the device profile by determining various settings or values associated or used by a corresponding device. For example, the proximate-device module 520 can determine the uploading-device profile 222, the downloading-device profile 224, or a combination thereof.

As a more specific example, the proximate-device module 520 can determine the uploading-device profile 222 of FIG. 2, the downloading-device profile 224 of FIG. 2, or a combination thereof by determining the accessible setting 226, the limited-access setting 228 of FIG. 2, the private setting 230 of FIG. 2, the setting-change flag 232, the access privilege 234 of FIG. 2, or a combination thereof. As a further specific example, the proximate-device module 520 can determine the device profile for the first device 102, the second device 106, the neighboring device 108, or a combination thereof.

The proximate-device module 520 can determine the device profile by determining the setting or value stored in the first storage unit 314 of FIG. 3, the second storage unit 346 of FIG. 3, the neighboring storage unit 414 of FIG. 4, or a combination thereof at a known location designated for the accessible setting 226, the limited-access setting 228, the private setting 230, the setting-change flag 232, the access privilege 234, or a combination thereof. The proximate-device module 520 can further determine the device profile by determining the setting or value using a protocol including a prompt, a request, a reply, or a combination thereof between devices.

For example, the second device 106 can determine the various settings stored or implemented in the first device 102 or the various setting values corresponding to the first device 102 and stored in the second device 106. The proximate-device module 520 can determine the downloading-device profile 224 for the first device 102, the second device 106, the neighboring device 108, or a combination thereof, including the corresponding device having the proximity zone 214 associated therewith, device within the proximity zone 214, devices unrelated to the proximity zone 214, or a combination thereof.

The proximate-device module 520 can determine the device profile of one or more devices within the computing system 100 from the perspective of the device itself. As a more specific example, the proximate-device module 520 can determine the downloading-device profile 224 for each of the devices.

As a further specific example, the proximate-device module 520 can determine the access privilege 234 as network passwords associated with specific network identification, membership information associated with accessibility information, such as conference registration or hotel check-in information associated with room or network access, a received key, or a combination thereof. Also as a more specific example, the proximate-device module 520 can determine the setting-change flag 232 to reflect that a mode or a status, such as “silent mode” or connection to a network, of the neighboring device 108 has changed, indicate the new mode or status, or a combination thereof.

Also for example, the first device 102 and the neighboring device 108 can determine the various information based on exchanging the accessible setting 226, the device location 236, the access privilege 234, or a combination thereof through broadcasting a request and replying to the request with the corresponding information.

As a more specific example, the proximate-device module 520 can determine the accessible setting 226 as public information, such as a setting for alerting a user of a device or a device identification information. The proximate-device module 520 can determine the limited-access setting 228 as privilege-based information, such as network or folder access based on password or membership. The proximate-device module 520 determine the limited-access setting 228 associated with the access privilege 234. The proximate-device module 520 can further determine the private setting 230 as personal passwords, usage history, personal content data, or a combination thereof.

The proximate-device module 520 can further calculate a confidence value 522 associated with a portion within the device profile. The confidence value 522 is a representation of likelihood of the user's intent in the setting value within the device profile. The confidence value 522 can be the highest rating or score if the setting value, such as a value in the accessible setting 226 or the access privilege 234 is based on a direct input from the user. The confidence value 522 can be based on an equation predetermined by the computing system 100 if the setting value is determined as part of a package or based on an estimate of the user's intent or context.

The proximate-device module 520 can select an instance of a device within the proximity zone 214 based on the device profile according to a device-selection mechanism 524. The device-selection mechanism 524 can be a process or a method for selecting a device within the proximity zone 214 for exchanging the transferable configuration setting 220. The device-selection mechanism 524 can include a scenario or an evaluation, a predetermined threshold, a step or an instruction, an equation or a formula, or a combination thereof.

For example, the proximate-device module 520 can select the neighboring device 108 in the proximity zone 214 associated with the first device 102 based on the device-selection mechanism 524 including comparison of the access privilege 234 for the first device 102 and the neighboring device 108. The proximate-device module 520 can further include instructions or steps to select the neighboring device 108 including the access privilege 234 less than, greater than, equal to, or a combination thereof relative to the access privilege 234 of the first device 102.

Also for example, the proximate-device module 520 can select the neighboring device 108 using the device-selection mechanism 524 for detecting devices attending the same instance of the event 202 in the accessible setting 226 or the limited-access setting 228, detecting the identification information in the accessible setting 226 and cross-matching to a predetermined list of device identifications, or a combination thereof. The proximate-device module 520 can select the neighboring device 108 as any device attending the same instance of the event 202, a device identified within the predetermined list, having a specific mode, such as a “silent” mode or a mode associated with the event 202, or a combination thereof.

The proximate-device module 520 can determine the uploading-device profile 222 as the device profile of the selected device within the proximity zone 214. The proximate-device module 520 can determine the downloading-device profile 224 as the device profile of the device used to define the proximity zone 214. The uploading-device profile 222 and the downloading-device profile 224 can represent the neighboring device 108 and the first device 102.

For example, the proximate-device module 520 can determine the uploading-device profile 222 as the device profile of the neighboring device 108 within the proximity zone 214 associated with the first device 102. Also for example, the proximate-device module 520 can determine the downloading-device profile 224 as the device profile of the first device 102 having the proximity zone 214 associated therewith.

For illustrative purposes the first device 102 is described as being associated with the proximity zone 214 and the neighboring device 108 as an uploading source for transferring the device configuration 207 to the first device 102. However, it is understood that the neighboring device 108 can have the proximity zone 214 associated therewith and the first device 102 can be the uploading source.

The proximate-device module 520 can also determine the downloading-device profile 224. The proximate-device module 520 can separately determine the uploading-device profile 222 for all instances of the devices within the proximity zone 214. The proximate-device module 520 can select the device as described above and the uploading-device profile 222 associated therewith.

The proximate-device module 520 can determine the proximate-device identity 216 as the identification information of the selected device within the proximity zone 214. The proximate-device module 520 can further determine the proximate-device identity 216 as the uploading-device profile 222 or a portion therein.

The proximate-device module 520 can further determine the proximate-device identity 216 based on the future context 204. The proximate-device module 520 can determine the proximate-device identity 216 as the identification information or the device profile of a device associated with the future context 204, such as based on a location, an organizer or presenter, a function, or a combination thereof.

For example, the proximate-device module 520 can determine the proximate-device identity 216 as the projector or a main computer connected thereto when the future context 204 includes a meeting room, a use of the projector for the event 202, or a combination thereof. Also for example, the proximate-device module 520 can determine the proximate-device identity 216 as the personal device belonging to the user having similar function or capacity as the downloading-device profile 224.

The proximate-device module 520 can determine the proximate-device identity 216 to be the device related to the future context 204 or the current context. For example, the proximate-device identity 216 can be the device associated with a controller or a manager of the event 202. Also for example, the proximate-device identity 216 can be all devices owned by the user.

It has been discovered that the proximate-device identity 216 and the proximity zone 214 provide improved usability for the user. The proximate-device identity 216 and the proximity zone 214 provide improved usability by identifying near-by devices that are further contextually related to the user. The identification of the near-by relevant devices can be used to further identify configuration settings that are relevant to the user in light of the future context 204 without requiring the user to identify all relevant features or configuration setting values.

After identifying the proximate-device identity 216, determining the proximity zone 214, or a combination thereof the control flow can pass from the surroundings module 504 to the event identification module 506. The control flow can pass similarly as described above between the context module 502 and the surroundings module 504.

The event identification module 506 is configured to initiate the transfer of the device configuration 207. The event identification module 506 can initiate the transfer based on the trigger metric 218 of FIG. 2, the transfer trigger 208, the contextual time-mark 210, or a combination thereof.

The event identification module 506 can identify the trigger metric 218 and evaluate the trigger metric 218 based on the transfer trigger 208 for initiating the transfer of the device configuration 207. The event identification module 506 can identify the trigger metric 218 based on data received into the corresponding device, such as user input or downloaded information, categories or types of information predetermined by the computing system 100, such as the current time 206 or the user's schedule calendar, or a combination thereof.

The event identification module 506 can identify the trigger metric 218 based on the contextual information 203. For example, the event identification module 506 can identify the trigger metric 218 for when the user is new to the geographical location or the event 202. Also for example, the event identification module 506 can identify the trigger metric 218 based on the contextual information 203 corresponding to the current time 206, the future context 204, or a combination thereof. As a more specific example, the event identification module 506 can identify the trigger metric 218 based on a categorization indicating social importance or user-specific importance for the contextual information 203, such as a meeting or a birthday.

The event identification module 506 can identify the trigger metric 218 as crowd-sourcing threshold. The event identification module 506 can identify the trigger metric 218 as a number of devices having or switching to a specific setting value in the corresponding instances of the device configuration 207 as indicated by the contextual information 203 corresponding to the current time 206.

For example, the event identification module 506 can identify the trigger metric 218 as a number of devices having the specific setting value including the transferable configuration setting 220, such as silent or connected to a specific router, within the proximity zone 214, among instances of the proximate-device identity 216, or a combination thereof. Also for example, the event identification module 506 can identify the trigger metric 218 as a number of devices switching to the specific setting value within a time duration relative to the current time 206 or a time associated with the event 202.

The event identification module 506 can evaluate the trigger metric 218 by comparing to the transfer trigger 208. The event identification module 506 can initiate the transfer when the trigger metric 218 satisfies the transfer trigger 208.

For example, the transfer trigger 208 stored in the second device 106 can include common ownership, located at user's home, or a combination thereof. The event identification module 506 can identify the trigger metric 218 as the ownership information, the device location 236, or a combination thereof for the uploading-device profile 222, the downloading-device profile 224, or a combination thereof based on the transfer trigger 208. The event identification module 506 can initiate the transfer when the user brings home the first device 102 newly purchased by the user.

Also for example, the transfer trigger 208 stored in the first device 102 can include a threshold number of participant devices, such as 75% or more than 5, switching to or having the “silent” mode. The event identification module 506 can identify the trigger metric 218 as the setting-change flag 232, a device identification, a user identification, a mode identification, the membership information, or a combination thereof. The event identification module 506 can initiate the transfer when the number of devices, the number of users, the number of participants for the event 202, or a combination thereof as identified by the trigger metric 218 further includes “silent” mode in the device profile or switches thereto as required by the transfer trigger 208.

As a more specific example, the event identification module 506 can identify the setting-change flag 232 by identifying the devices within the proximity zone 214 with a specific value or changes for the setting-change flag 232. The event identification module 506 can initiate the transfer when a magnitude of the change, a type or a categorization, a last-changed time, a number of devices having a specific value or a specific type of change, or a combination thereof for the setting-change flag 232 satisfies the transfer trigger 208 associated with the future context 204.

The event identification module 506 can also initiate the transfer based on the current time 206, the contextual time-mark 210, and the transfer offset 212. The event identification module 506 can initiate the transfer when the current time 206 matches the contextual time-mark 210 or a combination of the contextual time-mark 210 and the transfer offset 212. The event identification module 506 can further initiate the transfer when the current time 206 is within a window defined by the contextual time-mark 210, the transfer offset 212, or a combination thereof.

The event identification module 506 can further initiate the transfer based on the uploading-device profile 222, the downloading-device profile 224, or a combination thereof. The event identification module 506 can compare the downloading-device profile 224 and the uploading-device profile 222 and initiate the transfer based on a magnitude difference 526.

The magnitude difference 526 is a representation of the quantity, quality, amount, or a combination thereof differing between values for a common aspect between the downloading-device profile 224 and one or more instances of the uploading-device profile 222. For example, the magnitude difference 526 can represent differences in volume settings, brightness, the communication speed, or a combination thereof.

As a more specific example, the event identification module 506 can calculate the magnitude difference 526 for volume levels for an audio-media playback or a user-notification mechanism between the first device 102 and the neighboring device 108, any other device in the proximity zone 214, or a combination thereof. As a further specific example, the event identification module 506 can calculate the magnitude difference 526 for the communication rate 239 for identical instances of the communication mode 238.

The event identification module 506 can further calculate the magnitude difference 526 based on multiple instances of the uploading-device profile 222. For example, the event identification module 506 can calculate the magnitude difference 526 between the mean or median setting value for multiple instances of the devices in the proximity zone 214 and the downloading-device profile 224.

The event identification module 506 can compare the magnitude difference 526 to a difference threshold having a maximum limit, a minimum limit, or a combination thereof predetermined by the computing system 100. The event identification module 506 can initiate the transfer when the magnitude difference 526 is outside of the difference threshold.

It has been discovered that the magnitude difference 526 between the uploading-device profile 222 and the downloading-device profile 224 provides optimization for the user and minimizing unintended circumstances. The magnitude difference 526 can be used to determine situations where the user's devices are not performing as well as others based on possible issues with the device configuration 207 or where the device configuration 207 does not correctly anticipate the future context 204. The magnitude difference 526 can provide quantitative evaluation for determining sub-optimal performance or anticipatory error for the future context 204.

The event identification module 506 can further initiate the transfer based on a priority condition 528. The priority condition 528 can be a representation of importance or immediacy in initiating the configuration transfer.

The priority condition 528 can be based on one or a combination of factors, such as a current context, the future context 204, the device profile for one or more devices in the proximity zone 214, the magnitude difference 526, or a combination thereof. The priority condition 528 can be represented by one or more factors, a rating or a score representing the importance or the immediacy, or a combination thereof. The priority condition 528 can be similar to the device-selection mechanism 524 and be predetermined by the computing system 100.

For example, the event identification module 506 can include the priority condition 528 having the rating to immediately initiate the configuration transfer based on the device location 536 being in a funeral home or a conference room, certain categories or values of the current context or the future context 204, such as a wedding or a meeting with a client, the magnitude difference 526 exceeding the difference threshold, or a combination thereof. Also for example, the priority condition 528 can have the rating to initiate the configuration transfer when the user accesses a specific function or a device, such as a printer or a web browser.

It has been discovered that the priority condition 528 based on the future context 204 provides efficiency for the computing system 100 in transferring the device configuration 207. The priority condition 528 can quantize the importance of transferring the device configuration 207 in anticipation of the future context 204. The computing system 100 can use the priority condition 528 to schedule the transfer along with other tasks to maximize the efficiency for the overall system.

The event identification module 506 can further notify and prompt the user for confirmation before initiating the transfer. The event identification module 506 can use the first user interface 318, the second user interface 338, the neighboring user interface 418, or a combination thereof to notify and prompt the user.

The event identification module 506 can further initiate the transfer without a confirmation or a selection. For example, the event identification module 506 can initiate the transfer without previously communicating the configuration notification 240 to the user, such as by audibly recreating or displaying the configuration notification 240. Also for example, the event identification module 506 can initiate the transfer without a direct and contemporaneous interaction with the user based on the priority condition 528, the magnitude difference 526, or a combination thereof.

The event identification module 506 can further initiate the transfer based on the user interaction according to the change setting 242 for the overall device or the specific function or setting. For example, the event identification module 506 can initiate the transfer without the user interaction when the setting category or name is identified by the computing system 100 as having the dynamic setting 244. Also for example, the event identification module 506 can initiate or wait for the user interaction when the first device 102 used by the user includes the downloading-device profile 224 having static setting 246 for the overall setting of the device.

The event identification module 506 can initiate the transfer through passing of the control flow from the event identification module 506 to the configuration transfer module 508. The control flow can pass similarly as described above between the context module 502 and the surroundings module 504.

The configuration transfer module 508 is configured to transfer the device configuration 207. The configuration transfer module 508 can use the first communication unit 316, the second communication unit 336, the neighboring communication unit 416, or a combination thereof to communicate the transferable configuration setting 220 of FIG. 2.

The configuration transfer module 508 can communicate the transferable configuration setting 220 by exchanging the device configuration 207 or a portion thereof between the first device 102, the neighboring device 108, the second device 106, or a combination thereof. The configuration transfer module 508 can transmit the uploading-device profile 222 or a portion therein to the device having the proximity zone 214 associated therewith.

For example, the configuration transfer module 508 can send the uploading-device profile 222 or a portion therein as the transferable configuration setting 220 from the neighboring device 108 in the proximity zone 214 around the first device 102. The first device 102 can receive the uploading-device profile 222.

The configuration transfer module 508 can communicate the transferable configuration setting 220 from multiple devices in the proximity zone 214. The configuration transfer module 508 can collect multiple instances of the transferable configuration setting 220. The configuration transfer module 508 can also communicate the transferable configuration setting 220 with a specific device using the proximate-device identity 216.

The configuration transfer module 508 can communicate the transferable configuration setting 220 based on various factors used to initiate the transfer of the device configuration 207 as determined by the event identification module 506. For example, the configuration transfer module 508 can communicate the transferable configuration setting 220 based on the future context 204, the transfer trigger 208, the trigger metric 218, the uploading-device profile 222, the downloading-device profile 224, the setting-change flag 232 or a different portion therein, or a combination thereof as described above.

The configuration transfer module 508 can further communicate the transferable configuration setting 220 between devices without previously communicating the configuration notification 240. The configuration transfer module 508 can communicate the transferable configuration setting 220 with or without a previous interaction with the user based on the change setting 242, on the transfer offset 212, the contextual time-mark 210, or a combination thereof as described above.

The configuration transfer module 508 can include a transfer mode module 530, a configuration generator module 532, or a combination thereof for communicating the transferable configuration setting 220. The transfer mode module 530 is configured to determine the communication mode 238 based on the access privilege 234 for communicating the transferable configuration setting 220.

The transfer mode module 530 can determine the communication mode 238 based on receiving the preliminary information including the access privilege 234. The transfer mode module 530 can determine the communication mode 238 using the first communication interface 328, the second communication interface 350, the neighboring communication interface 428, or a combination thereof. The transfer mode module 530 can determine the communication mode 238 by selecting a communication protocol or a medium, such as WiFi or short-range communication, establishing a connection or a network between devices, or a combination thereof.

For example, the transfer mode module 530 can determine the communication mode 238 as the short-range communication method if the membership information, the identification information of the device in the proximity zone 214, the access privilege of the user's device, or a combination thereof do not coincide. Also for example, the transfer mode module 530 can establish or connect to a network based a common instance of the membership information, identification information matching a trusted device list or a previous connection history, an authentication information, such as a user name or password, or a combination thereof on the first device 102, the second device 106, the neighboring device 108, or a combination thereof.

The configuration generator module 532 is configured to generate the transferable configuration setting 220. The configuration generator module 532 can generate the transferable configuration setting 220 in a variety of ways.

For example, the configuration generator module 532 can generate a configuration data request for communicating from the downloading device to the uploading device. The configuration data request can be for a specific identification of the configuration setting or a category of the configuration setting. The configuration data request can also be for all available or sharable data. The configuration generator module 532 can further generate the transferable configuration setting 220 as the setting value in the uploading-device profile 222 corresponding to the configuration data request.

Also for example, the configuration generator module 532 can generate the transferable configuration setting 220 based on comparing the uploading-device profile 222 and the downloading-device profile 224. The transferable configuration setting 220 can compare the accessible setting 226, including the identification information for the device or the owner the access privilege, communicated and determined by the surroundings module 506 as described above.

As a more specific example, the configuration generator module 532 can generate the transferable configuration setting 220 to include up to the private setting 230 when the uploading-device profile 222 and the downloading-device profile 224 indicate common ownership by the user. As a further specific example, the configuration generator module 532 can generate the transferable configuration setting 220 to include up to the limited-access setting 228 in the uploading-device profile 222 based on the membership or identification information of the communicating devices, the access privilege 234 of the downloading-device profile 224, or a combination thereof.

For further example, the configuration generator module 532 can generate the transferable configuration setting 220 based on multiple instances of the device configuration 207 for multiple devices in the proximity zone 214. The configuration generator module 532 can generate the transferable configuration setting 220 including a value for the setting based on an average, a mean, a most commonly occurring, or a combination thereof value for the corresponding values among the multiple instances of the device configuration 207.

The configuration generator module 532 can further adjust the value based on a similarity between devices. The configuration generator module 532 can determine the similarity level as a score or a match. The configuration generator module 532 can use the device identification, the device categorization, a list of corresponding features or settings, the owner identification, a manufacturer identification, or a combination thereof. The configuration generator module 532 can compare the uploading-device profile 222, the downloading-device profile 224, initially exchanged and determined information from the surroundings module 504, or a combination thereof.

The configuration generator module 532 can use the setting values from the uploading device having the highest similarity level or setting values above a similarity threshold as compared to the downloading device to generate or adjust the value for the transferable configuration setting 220. The configuration generator module 532 can include the similarity threshold, a method or a process for determining the similarity level, the list of features corresponding to devices and associated similarities there-between, or a combination thereof for generating or adjusting the value for the transferable configuration setting 220 based on similarity between devices.

The configuration generator module 532 can generate the transferable configuration setting 220 by encrypting the device configuration 207 information. The configuration generator module 532 can encrypt for all instances of the transferable configuration setting 220, based on ownership, based on the access privilege 234, based on membership or grouping information, based on the content of the transferable configuration setting 220, such as including the limited-access setting 228 or the private setting 230, based on the device location 536 and the current context, based on the future context 204, or a combination thereof.

The configuration generator module 532 can further generate the transferable configuration setting 220 to include a sequential information set. For example, the access privilege 234 or access information can be communicated first. The access privilege 234 or the access information can be used by the transfer mode module 530 for adjusting the communication mode 238 with a higher instance of the communication rate 239. The transferable configuration setting 220 can include other information subsequent to the initial communication for communicating using the communication mode 238 with the higher instance of the communication rate 239 established with the initial communication.

It has been discovered that the transferable configuration setting 220 provides contextually relevant configurations with minimal burden on the user. The transferable configuration setting 220 can provide contextual relevance based on determining the future context 204, the settings for nearby devices, or a combination thereof. The transferable configuration setting 220 based on the nearby devices can further adapt to an unknown context, or a change or a determination error in the context. The computing system 100 can use the transferable configuration setting 220 to adapt the devices without requiring the user to determine individual settings.

It has also been discovered that the transferable configuration setting 220 and the future context 204 provide timely and contextually relevant features to the user. The transferable configuration setting 220 and the future context 204 can anticipate and implement the necessary changes for the event 202 occurring at a later time. The anticipation and earlier implementation of setting changes can provide the necessary functions at the time of the event 202 instead of reacting to the event 202 itself.

After generating the transferable configuration setting 220, the control flow can pass from the configuration transfer module 508 to the device configuration module 510. The control flow can pass similarly as described above between the context module 502 and the surroundings module 504.

Alternatively, the computing system 100 can be based on communicating information between devices within the proximity zone 214. For example, the surroundings module 504 can establish a connection, a protocol, a local-impromptu network, or a combination thereof between the devices within the proximity zone 214, using the proximate-device identity 216, or a combination thereof. Also for example, the event identification module 506, the transfer trigger 208, or a combination thereof can be based on the connection, the protocol, the local-impromptu network, or a combination thereof.

The configuration transfer module 508 can poll the devices, or transmit and receive broadcasts from the devices based on various conditions. The transfer trigger 208, such as for the crowd-sourcing threshold, can be compared to the polled response or the broadcasted response for implementing the transferable configuration setting 220.

For example, the event identification module 506 can establish the connection, the protocol, the localized network, or a combination thereof for the devices within the proximity zone 214 to broadcast the transferable configuration setting 220 based on a change in setting or value therein, or at a periodic basis. Also for example, the event identification module 506 can poll the devices for the transferable configuration setting 220 on a periodic basis, such as based on a time associated with the event 202. The device configuration module 510 can use the polled responses or the broadcasted instances of the transferable configuration setting 220 to implement the transferable configuration setting 220.

The device configuration module 510 is configured to implement the changes in the device configuration 207. The device configuration module 510 can adjust the downloading-device profile 224 based on the transferable configuration setting 220 for configuring the downloading device.

For example, the device configuration module 510 can change the downloading-device profile 224 of the first device 102. The device configuration module 510 can use the transferable configuration setting 220 based on one or more devices in the proximity zone 214 around the first device 102. Also for example, the device configuration module 510 can use the downloading-device profile 224 from the neighboring device 108 having the proximate-device identity 216.

The device configuration module 510 can use the first control unit 312, the second control unit 334, the neighboring control unit 412, or a combination thereof to change the downloading-device profile 224 according to the transferable configuration setting 220. The updated instance of the downloading-device profile 224 can be stored in the first storage unit 314, the second storage unit 346, the neighboring storage unit 414, or a combination thereof.

The device configuration module 510 can further generate the configuration notification 240 associated with adjusting the downloading-device profile 224. The device configuration module 510 can generate the configuration notification 240 using the first user interface 318, the second user interface 338, the neighboring user interface 418, or a combination thereof for communicating with the user, such as by audibly recreating sounds or displaying a message. The device configuration module 510 can generate the configuration notification 240 before or after adjusting the downloading-device profile 224.

For example, the device configuration module 510 can generate the configuration notification 240 to notify the user of a common setting found in devices nearby and query the user for approval to adjust the downloading-device profile 224 according to the transferable configuration setting 220. As a more specific example, the device configuration module 510 can generate the configuration notification 240 to notify the user that a majority of the nearby devices or a percentage of the devices are in “silent mode” or connected to a specific network. The device configuration module 510 can adjust the downloading-device profile 224 to conform to the other devices based on the user's approval.

Also for example, the device configuration module 510 can generate the configuration notification 240 to notify the user of various available settings across multiple nearby devices and highlight a setting based on the most common setting value, the similarity level between the user's device and others, the confidence value 522 of the setting values for the uploading-device profile 222, a variance between the setting value across the multiple instances of the other devices, or a combination thereof. The device configuration module 510 can adjust the downloading-device profile 224 based on the user's selection in response to the configuration notification 240.

As a further example, the device configuration module 510 can generate the configuration notification 240, adjust the downloading-device profile 224, or a combination thereof when the user accesses a relevant feature of the device. The device configuration module 510 can generate the configuration notification 240, adjust the downloading-device profile 224, or a combination thereof contemporaneous with the user's access based on the priority condition 528.

For further example, the device configuration module 510 can adjust the downloading-device profile 224 and subsequently generate the configuration notification 240. The device configuration module 510 can adjust the downloading-device profile 224 prior to generating the configuration notification 240 based on the setting identification or category, the future context 204 or the current context, the priority condition 528, the magnitude difference 526, or a combination thereof. The device configuration module 510 can subsequently generate the configuration notification 240 to notify the user that the downloading-device profile 224 has been adjusted according to the transferable configuration setting 220.

The updated instance of the downloading-device profile 224 can change or adjust the criteria for determining the proximity zone 214, the proximate-device identity 216, or a combination thereof. The computing system 100 can repeat the above described process to further update the downloading-device profile 224 using a different instance of the transferable configuration setting 220 based on adjusting the device configuration 207.

It has been discovered that the transferable configuration setting 220, the proximity zone 214, and the device profile provides contextually aware usability for the user. The transferable configuration setting 220, the proximity zone 214, and the device profile can be used to recognize new devices being added on to an existing network by the user and to configure the devices appropriately.

For example, the user can install a new printer. The transferable configuration setting 220, the proximity zone 214, and the device profile can be used to recognize the context and appropriately load the configuration settings for the new printer, other devices in the network belonging to the user, or a combination thereof.

Also for example, the user can check into a hotel or a conference. The transferable configuration setting 220, the proximity zone 214, and the device profile can be used to recognize the context appropriately load the configuration settings for connecting to the network in the hotel or the conference.

For illustrative purposes, the various modules have been described as being specific to the first device 102 or the second device 106. However, it is understood that the modules can be distributed differently. For example, the various modules can be implemented in a different device, or the functionalities of the modules can be distributed across multiple devices. Also as an example, the various modules can be stored in a non-transitory memory medium.

For a more specific example, the functions of the event identification module 506 and the configuration transfer module 508 can be merged and be specific to the first device 102 or the second device 106. Also for a more specific example, the function for determining the device profile and determining the proximate-device identity 216 of the proximate-device module 520 can be separated into different modules, separated across the first device 102 and the second device 106, or a combination thereof. As a further specific example, one or more modules show in FIG. 5 can be stored in the non-transitory memory medium for distribution to a different system, a different device, a different user, or a combination thereof.

The modules described in this application can be stored in the non-transitory computer readable medium. The first storage unit 314, the second storage unit 346, the neighboring storage unit 414, or a combination thereof can represent the non-transitory computer readable medium. The first storage unit 314, the second storage unit 346, the neighboring storage unit 414, or a combination thereof or a portion thereof can be removable from the first device 102 or the second device 106. Examples of the non-transitory computer readable medium can be a non-volatile memory card or stick, an external hard disk drive, a tape cassette, or an optical disk.

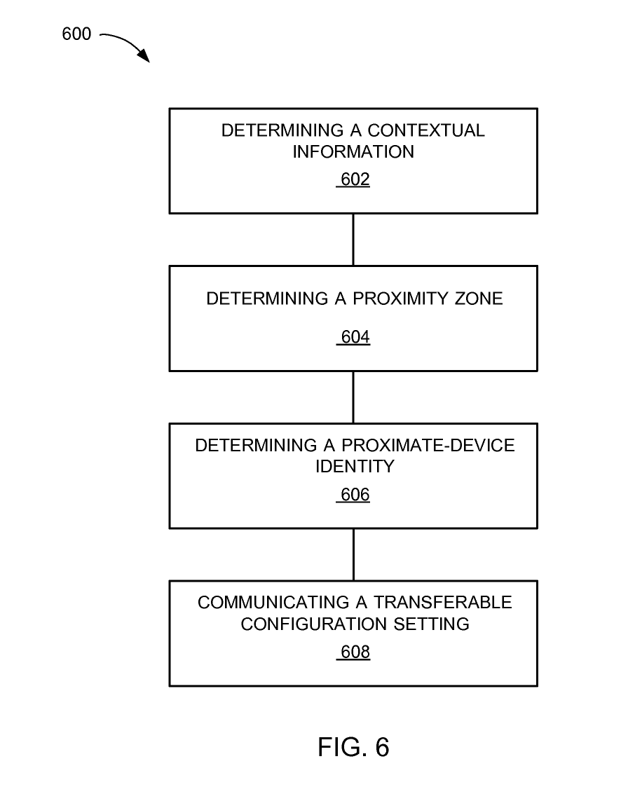

Referring now to FIG. 6, therein is shown a flow chart of a method 600 of operation of a computing system 100 in a further embodiment of the present invention. The method 600 includes: determining a contextual information for representing the contextual information relative to a device in a block 602; determining a proximity zone for identifying further devices within the proximity zone relative to a device in a block 604; determining proximate-device identities for identifying the further devices relative to the device in a block 606; and communicating a transferable configuration setting with a communication unit using the proximate-device identity for updating the device based on the transferable configuration setting for displaying on the device.

It has been discovered that the transferable configuration setting 220 of FIG. 2 provides contextually relevant configurations with minimal burden on the user. It has also been discovered that the transferable configuration setting 220 and the future context 204 of FIG. 2 provide timely and contextually relevant features to the user.

It has been discovered that the transfer trigger 208 of FIG. 2 can provide contextually relevant and situation-appropriate and timely adaptations and features for the computing system 100. It has also been discovered that the proximate-device identity 216 of FIG. 2 and the proximity zone 214 of FIG. 2 provide improved usability for the user. It has further been discovered that the magnitude difference 526 between the uploading-device profile 222 and the downloading-device profile 224 provides optimization for the user and reduces unintended circumstances.

The physical transformation from the transferable configuration setting 220 results in movement in the physical world, such as changing a volume level or displaying a notice on the first device 102. Movement in the physical world results in updates to the trigger metric 218, which can be fed back into the computing system 100 and used to further update the downloading-device profile 224 using the transferable configuration setting 220 according to the future context 204.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a context module configured to determine a contextual information for representing the contextual information relative to a device;
a zone module, coupled to the context module, configured to determine a proximity zone for identifying further devices within the proximity zone relative to the device;
a proximate-device module, coupled to the zone module, configured to determine proximate-device identities for identifying the further devices relative to the device; and
a configuration transfer module, coupled to the proximate-device module, configured to communicate a transferable configuration setting with a communication unit using the proximate-device identities for updating the device based on the transferable configuration setting and the contextual information for displaying on the device.

2. The system as claimed in claim 1 further comprising:
a context-determination module, coupled to the zone module, configured to determine a future context for updating the device;
wherein:
the configuration transfer module is configured to communicate the transferable configuration setting based on the future context.

3. The system as claimed in claim 1 further comprising:
a timing module, coupled to the zone module, configured to determine a contextual time-mark for temporally representing a future context;
an offset module, coupled to the timing module, configured to calculate a transfer offset relative to the contextual time-mark; and
wherein:
the configuration transfer module is configured to communicate the transferable configuration setting according to the transfer offset and the contextual time-mark.

4. The system as claimed in claim 1 wherein:
the proximate-device module is configured to determine an uploading-device profile and a downloading-device profile for representing the device and the further devices; and
further comprising:
a configuration generator module, coupled to the proximate-device module, configured to generate the transferable configuration setting based on the uploading-device profile and the downloading-device profile for communicating the transferable configuration setting.

5. The system as claimed in claim 1 further comprising:
an event identification module, coupled to the zone module, configured to detect a trigger metric; and
wherein:
the configuration transfer module is configured to communicate the transferable configuration setting based on the trigger metric without previously displaying a configuration notification.

6. The system as claimed in claim 1 further comprising:
a context-determination module, coupled to the zone module, configured to determine a future context for describing an event surrounding the device, the further devices, or a combination thereof;
a device configuration module, coupled to the configuration transfer module, configured to set a downloading-device profile based on the transferable configuration setting for configuring the device based on the transferable configuration setting;
wherein:
the configuration transfer module is configured to communicate the transferable configuration setting based on the future context for communicating the transferable configuration setting from the further devices to the device; and

7. The system as claimed in claim 6 wherein:
the proximate-device module is configured to determine an access privilege for describing the device, the further devices, or a combination thereof; and
further comprising:
a transfer mode module, coupled to the proximate-device module, configured to determine a communication mode based on the access privilege for communicating the transferable configuration setting.

8. The system as claimed in claim 6 wherein:
the proximate-device module is configured to determine an uploading-device profile for representing the further devices, the uploading-device profile including an accessible setting, a limited-access setting, or a combination thereof; and
further comprising:
a configuration generator module, coupled to the proximate-device module, configured to generate the transferable configuration setting based on the accessible setting, the limited-access setting, or a combination thereof.

9. The system as claimed in claim 6 wherein the proximate-device module is configured to determine the proximate-device identities based on a device-selection mechanism for selecting the further devices.

10. The system as claimed in claim 6 further comprising:
an event identification module, coupled to the context-determination module, configured to identify a setting-change flag for representing a change in the further devices; and
wherein:
the configuration transfer module is configured to communicate the transferable configuration setting based on the setting-change flag.

11. A method of operation of a computing system comprising:
determining a contextual information for representing the contextual information relative to a device;
determining a proximity zone for identifying further devices within the proximity zone relative to a device;
determining proximate-device identities for identifying the further devices relative to the device; and
communicating a transferable configuration setting with a communication unit using the proximate-device identities for updating the device based on the transferable configuration setting for displaying on the device.

12. The method as claimed in claim 11 wherein:
determining the contextual information includes determining a future context for updating the device; and
communicating the transferable configuration setting includes communicating the transferable configuration setting based on the future context.

13. The method as claimed in claim 11 further comprising:
determining a contextual time-mark for temporally representing a future context;
calculating a transfer offset relative to the contextual time-mark; and
wherein:
communicating the transferable configuration setting includes communicating the transferable configuration setting according to the transfer offset and the contextual time-mark.

14. The method as claimed in claim 11 further comprising:
determining an uploading-device profile and the downloading-device profile for representing the device and the further devices; and
generating the transferable configuration setting based on the uploading-device profile and the downloading-device profile for communicating the transferable configuration setting.

15. The method as claimed in claim 11 further comprising:
detecting a trigger metric; and
wherein:
communicating the transferable configuration setting includes communicating the transferable configuration setting based on the trigger metric without previously displaying a configuration notification.

16. A non-transitory computer readable medium including instructions comprising:
determining a contextual information for representing the contextual information relative to a device;
determining a proximity zone for identifying further devices within the proximity zone relative to a device;
determining a proximate-device identities for identifying the further devices relative to the device; and
communicating a transferable configuration setting with a communication unit using the proximate-device identities for updating the device based on the transferable configuration setting for displaying on the device.

17. The non-transitory computer readable medium as claimed in claim 16 wherein:
determining the contextual information includes determining a future context for updating the device; and
communicating the transferable configuration setting includes communicating the transferable configuration setting based on the future context.

18. The non-transitory computer readable medium as claimed in claim 16 further comprising:
determining a contextual time-mark for temporally representing the future context;
calculating a transfer offset relative to the contextual time-mark; and
wherein:
communicating the transferable configuration setting includes communicating the transferable configuration setting according to the transfer offset and the contextual time-mark.

19. The non-transitory computer readable medium as claimed in claim 16 further comprising:
determining an uploading-device profile and the downloading-device profile for representing the device and the further devices; and
generating the transferable configuration setting based on the uploading-device profile and the downloading-device profile for communicating the transferable configuration setting.

20. The non-transitory computer readable medium as claimed in claim 16 further comprising:
detecting a trigger metric; and
wherein:
communicating the transferable configuration setting includes communicating the transferable configuration setting based on the trigger metric without previously displaying a configuration notification.
